(19) United States
(12) Patent Application Publication
(10) Pub. No.: US 2006/0022454 A1
(43) Pub. Date: Feb. 2, 2006

(54) Ring for visually determining the crimped status of a coupling for tubes

(75) Inventors: Pascal Le Clinche, Lyon (FR); Christian Dausson, Orleans (FR)

Correspondence Address: OLIFF & BERRIDGE, PLC, P.O. BOX 19928, ALEXANDRIA, VA, 22320, US

(73) Assignee: COMAP, Lyon (FR)

(21) Appl. No.: 11/185,005

(22) Filed: Jul. 20, 2005

(30) Foreign Application Priority Data
Jul. 29, 2004 (FR) 04.08393

(51) Int. Cl. F16L 55/00

(52) U.S. Cl. 285/93

(57) ABSTRACT

Ring for visually determining the crimped status of a coupling for tubes, comprising an annular portion exhibiting at least one recess revealing the body of the coupling and at least one fin situated facing a recess, the at least one fin comprising a first end connected to the annular portion and situated some distance from the coupling, and a second end situated near the body of the coupling so that the at least one fin is displaced by the crimping tool during the coupling crimping operation so as to at least partially close off the corresponding recess.

### BACKGROUND OF THE INVENTION

The present invention relates to a ring for visually determining the crimped status and which is intended for a coupling for tubes.

When installing a network of tubes, the fitter creates an assembly comprising, in particular, tubes and couplings in several phases, successively fitting a tube and a coupling together, then crimping during which the coupling is crimped onto the end of the tube to guarantee the lasting mechanical integrity of the installation and its sealing.

In order to guarantee the lasting leaktightness of the installation, it is necessary to crimp all the couplings. Various solutions have been envisioned for allowing the user to check that all the couplings have been crimped.

Creating a leak caused at the coupling until such time as the coupling has been crimped has, in particular, been envisioned. This approach allows the operator to detect the non-crimped couplings by pressurizing the installation then identifying the leaks, either visually or by observing a lower than normal pressure in the installation, thus allowing the crimping of the couplings of the installation to be checked globally. These leaks may be caused by seals of a special shape which do not seal until they have been crimped, this involving a costly manufacture and possibly involving a special positioning of the seal in a groove provided for that purpose. The leaks may also be caused by the shape of the coupling, thus making it possible to use common O-ring seals of constant cross section.

### DESCRIPTION OF THE PRIOR ART

In particular, documents DE 101 18 995 and WO 01/63160 describe two devices allowing such pre-crimping deliberate leaks to be brought about.

It has also been envisioned for use to be made of marking means present on each ring-shaped coupling, as described in documents WO 01/21997 or DE 100 02 916. However, these rings prove to be difficult to destroy during the crimping by the crimping tools, and produce waste which remains at the site of the installation and may contaminate the crimping tool.

### SUMMARY OF THE INVENTION

The object of the present invention is to provide a solution allowing the crimped status to be reliably determined visually, that does not leave waste on the site of the installation, and uses known crimping jaws.

Another object of the invention is to be able to use such a visual indication ring on couplings of the copper coupling type. In this type of coupling, the crimping jaws are not positioned by virtue of a positioning ring but through the mutually complementing nature of the shapes of a groove of the crimping jaw and a bulge situated on the coupling a determined distance from the socket, this bulge forming a groove housing a seal.

In consequence, with this type of positioning, it is not possible to provide a ring intended to be housed in a groove of the crimping jaw designed for a positioning ring.

To this end, the present invention relates to a ring for visually determining the crimped status of a coupling for tubes, which comprises an annular portion exhibiting at least one recess revealing the body of the coupling and at least one fin situated facing a recess, the fin comprising a first end connected to the annular portion and situated some distance from the coupling, and a second end situated near the body of the coupling so that the at least one fin is displaced by the crimping tool during the coupling crimping operation so as to at least partially close off the corresponding recess.

By virtue of these measures, the crimping tool exerts pressure on the fin toward the body of the coupling, the fin becoming housed in a recess, its second end sliding along the body of the coupling.

In addition, during crimping, the geometry of this ring is intended to be flattened, in order to avoid breakage, even in the absence of a housing groove in the crimping jaw facing the ring.

According to one possibility, the recesses are open on one edge of the annular portion.

According to one embodiment, the edge of the annular portion on which the recesses are open forms a collection of crenulations prior to crimping.

After crimping, the crenulations are closed off, this change providing the visual indication.

According to another possibility, the recesses are closed.

After crimping, the closed recesses forming windows are closed off, this change providing the visual indication.

Advantageously, the first end of at least one fin comprises a chamfer encouraging its displacement in a given direction with respect to the body of the coupling during crimping.

According to one embodiment, the first end of the fin has a radius, with respect to the axis of the coupling, smaller than the radius of the coupling, it being possible for the ring to be forcibly fitted onto the coupling.

Advantageously, the ring is made of a material allowing it to deform during crimping in such a way as to form, at the gaps between the jaws of the crimping tool, accumulations of material in the form of at least one flat tab, that can be broken off later by the user so as to remove the ring from the coupling.

According to one embodiment, the ring comprises at least two fins and two recesses distributed uniformly about the periphery of the ring.

Advantageously, the ring comprises at least four fins and four corresponding recesses.

The present invention also relates to a coupling comprising a ring as described hereinabove.

In any event, the invention will be clearly understood with the aid of the description which follows, with reference to the attached schematic drawing depicting, by way of nonlimiting example, several embodiments of a ring and of a coupling according to the invention.

### BRIEF DESCRIPTION OF THE DRAWINGS

FIG. 1 is a view in section of the socket of a coupling into which the end of a tube is introduced, the coupling bearing a ring according to the invention, according to a first embodiment, prior to crimping.

FIG. 2 is a partial sectioned view of the coupling of FIG. 1, after crimping.

FIG. 3 is a perspective view of the ring of FIG. 1, before crimping.

FIG. 4 is a perspective view of a ring according to the invention, according to a second embodiment, prior to crimping.

FIG. 5 is a side view of the ring of FIG. 4.

FIG. 6 is a sectioned view of the socket of a coupling into which the end of a tube is introduced, the coupling bearing the ring of FIG. 4, prior to crimping.

FIG. 7 is a perspective view of a ring according to the invention, according to a third embodiment, prior to crimping.

FIG. 8 is a sectioned view of the ring of FIG. 7, prior to crimping.

FIG. 9 is a sectioned view of a ring according to the invention, according to a fourth embodiment, prior to crimping.

FIG. 10 is a schematic partial perspective view of the ring of FIG. 9 after crimping.

### DESCRIPTION OF THE PREFERRED EMBODIMENTS

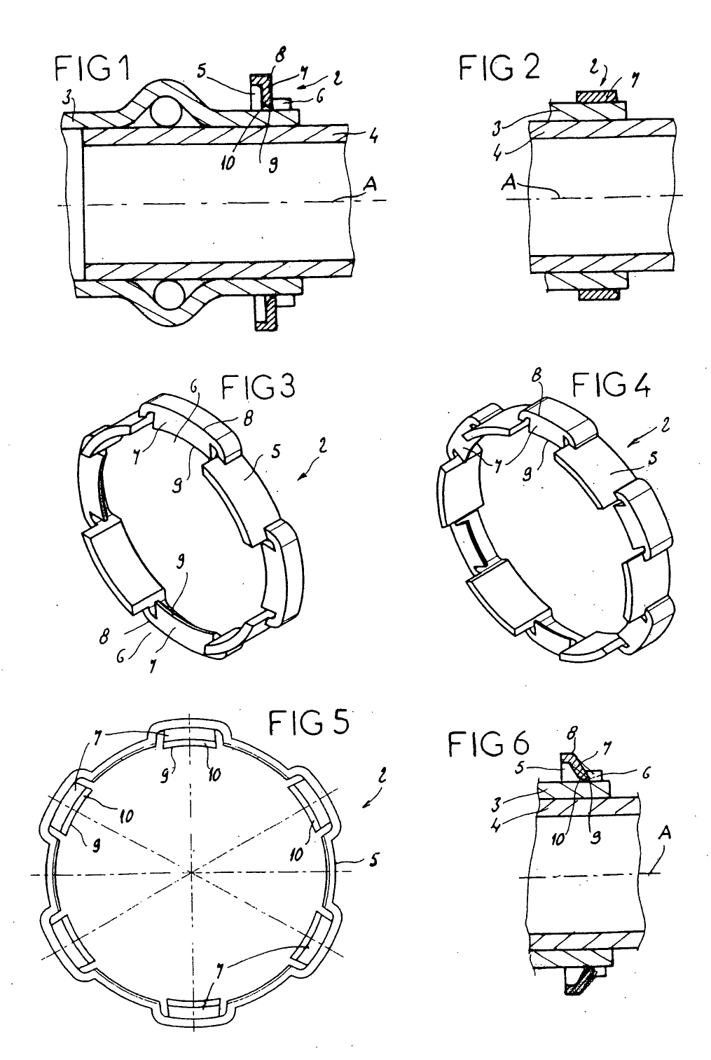

According to a first embodiment depicted in FIGS. 1 to 3, a ring 2 for visually determining the crimped status of a coupling 3 for tubes 4 comprises an annular portion 5 exhibiting recesses 6, open on one edge of the annular portion 5. The annular portion 5 therefore exhibits, prior to crimping, crenulations that the operator can see.

The ring 2 comprises fins 7 a first end 8 of which is connected to the annular portion 5 some distance from the coupling and a second end 9 of which is situated near the body of the coupling. Thus, during crimping, each fin 7 is displaced by the crimping tool, which bears at the first end 8 of the fin, at the connection to the annular portion 5, and deforms the ring, the fin 7 being displaced against the body of the coupling so as to at least partially close off a recess 6 facing it.

The second end 9 of the fin has a chamfer 10 encouraging the fin to be displaced in a given direction, particularly in the direction of the recess 6.

The ring 2 comprises four fins 7 and four corresponding recesses 6 uniformly distributed about the periphery of the ring so as to spread the loads uniformly during crimping and allow the crimped status to be visually determined irrespective of the orientation of the ring 2.

In this embodiment, the annular part 5 exhibits an internal radius more or less equal to the external radius of the body of the coupling in the regions not situated near the connection to a fin 7.

According to a second embodiment depicted in FIGS. 4 to 6, a ring 2 according to the invention comprises the same elements as in the first embodiment. However, in this embodiment, the second end 9 of each fin has a radius with respect to the axis A of the coupling that is smaller than the radius of the coupling. The ring has thus to be forcibly mounted on the socket of the coupling 3, and this on the one hand guarantees that the ring remains in position on the socket of the coupling and, on the other hand, allows the fins 7 to be inclined slightly toward the recess 6, the ring 2 being introduced over the socket of the coupling 3 by its opposite end to the recesses 6, this arrangement making it easier for the fin 7 to be displaced toward the recess 6 during crimping.

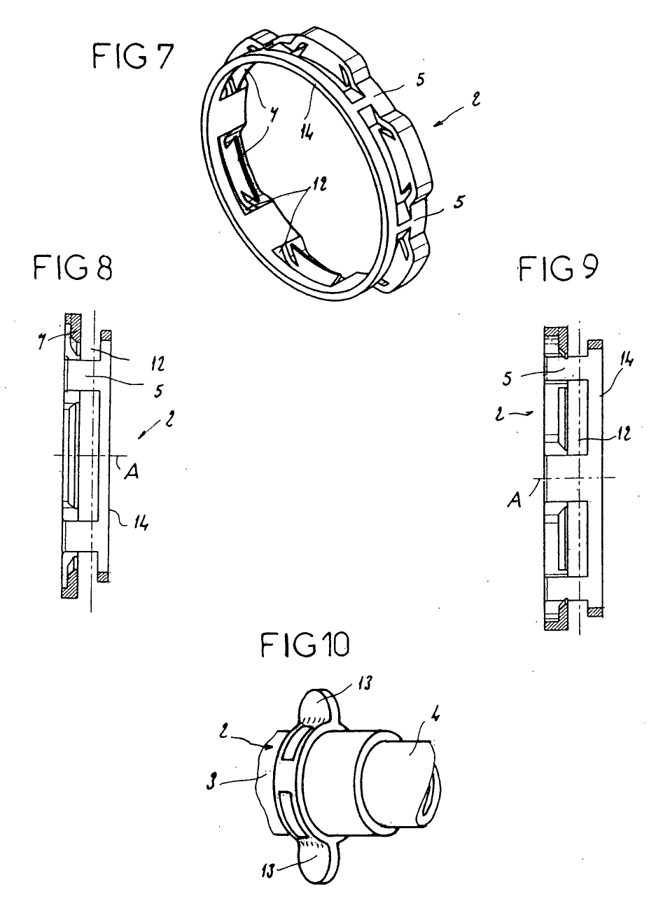

According to a third embodiment depicted in FIGS. 7 and 8, a ring 2 according to the invention comprises closed recesses 12 on the opposite edge of the annular portion to the part connected to the fins 7. In this embodiment, the crimped status is also visually determined by the at least partial closing-off of each recess 12 by a fin 7. The presence of a closed recess forms a continuous edge 14 of a diameter more or less equal to the diameter of the body of the coupling, strengthening the ring 2.

In this embodiment, the second end 9 of each fin 7 has a radius with respect to the axis A of the coupling more or less equal to the diameter of the coupling 3.

According to a fourth embodiment, which a variant of the third embodiment, depicted in FIGS. 9 and 10, a ring 2 according to the invention comprises the same elements as in the third embodiment. However, in this embodiment, the second end 9 of each fin has a radius with respect to the axis A of the coupling that is smaller than the radius of the coupling.

Thus, in a similar way to that which was explained for the second embodiment, the ring 2 has to be forcibly mounted on the socket of the coupling 3, and this guarantees, on the one hand, that the ring 2 remains in position on the socket of the coupling 3 and, on the other hand, allows the fins 7 to be inclined slightly toward the recess 6, the ring 2 being introduced over the socket of the coupling 3 via its opposite end to the recesses 12, this arrangement making it easier for the fin 7 to be displaced toward the recess 12 during crimping.

Advantageously, the ring 2 is made of a material that allows it to deform during crimping in such a way as to form, at the gaps between the jaws of the tool, accumulations of material in the form of flat tabs 13, as illustrated schematically in FIG. 10, it being possible for these tabs 13 to be broken off later by the user.

It should be pointed out that, for the embodiments in which the ring is not forcibly mounted over the socket of the coupling, it is possible to produce a boss at the end of the socket, after the ring has been introduced for example, to guarantee that the ring remains in position on the coupling, the boss forming at least one end stop on the exterior surface of the coupling preventing the ring from becoming lost.

As goes without saying, the invention is not restricted to the preferred embodiments described hereinabove by way of nonlimiting example; on the contrary, it encompasses all embodiment variants thereof that fall within the scope of the claims that follow.

1. A ring for visually determining the crimped status of a coupling for tubes, and which comprises an annular portion exhibiting at least one recess revealing the body of the coupling and at least one fin situated facing a recess, the at least one fin comprising a first end connected to the annular portion and situated some distance from the coupling, and a second end situated near the body of the coupling so that the at least one fin is displaced by the crimping tool during the coupling crimping operation so as to at least partially close off the corresponding recess.

2. The ring as claimed in claim 1, wherein the recesses are open on one edge of the annular portion.

3. The ring as claimed in claim 2, wherein the edge of the annular portion on which the recesses are open forms a collection of crenulations prior to crimping.

4. The ring as claimed in claim 1, wherein the recesses are closed.

5. The ring as claimed in claim 1, wherein the first end of at least one fin comprises a chamfer encouraging its displacement in a given direction with respect to the body of the coupling during crimping.

6. The ring as claimed in claim 1, wherein the first end of the fin has a radius, with respect to the axis (A) of the coupling, smaller than the radius of the coupling, it being possible for the ring to be forcibly fitted onto the coupling.

7. The ring as claimed in claim 1, and which is made of a material allowing it to deform during crimping in such a way as to form, at the gaps between the jaws of the crimping tool, accumulations of material in the form of at least one flat tab, that can be broken off later by the user so as to remove the ring from the coupling.

8. The ring as claimed in claim 1, and which comprises at least two fins and two recesses distributed uniformly about the periphery of the ring.

9. The ring as claimed in claim 8, and which comprises at least four fins and four corresponding recesses.

10. A crimped coupling for a tube, comprising at least one ring as claimed in claim 1.
